(19) United States
(12) Patent Application Publication
(10) Pub. No.: US 2007/0076954 A1
(43) Pub. Date: Apr. 5, 2007

(54) FACE ORIENTATION IDENTIFYING METHOD, FACE DETERMINING METHOD, AND SYSTEM AND PROGRAM FOR THE METHODS

(76) Inventor: Kensuke Terakawa, Kanagawa-ken (JP)

Correspondence Address: BIRCH STEWART KOLASCH & BIRCH, PO BOX 747, FALLS CHURCH, VA, 22040-0747, US

(21) Appl. No.: 11/538,434

(22) Filed: Oct. 3, 2006

(30) Foreign Application Priority Data
Oct. 3, 2005 (JP) 289749/2005

(51) Int. Cl. G06K 9/46; G06K 9/62

(52) U.S. Cl. 382/190; 382/228

(57) ABSTRACT

An index representing the probability that an input image is a face image including a face oriented in a predetermined orientation is calculated for each of different predetermined orientations on the basis of a feature value of the input image including a face and the orientation of the face included in the input image is identified on the basis of the ratio of the indexes which have been calculated for the different predetermined orientations.

This application claims priority to Japanese patent application Serial No. 289749/2005 filed Oct. 3, 2005.

The foregoing applications, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention. Citation or identification of any document in this application is not an admission that such document is available as prior art to the present invention. It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention. The embodiments of the present invention are disclosed herein or are obvious from and encompassed by, the detailed description. The detailed description, given by way of example, but not intended to limit the invention solely to the specific embodiments described, may best be understood in conjunction with the accompanying drawings.

### BACKGROUND OF THE INVENTION

1. Field of the Invention

This invention relates to a method of identifying the orientation of a face in a digital face image (a digital image including a face), a method of determining whether the input digital image is a face image including therein a face, and a system and a computer program for carrying out these methods.

2. Description of the Related Art

There have been investigated various face detecting methods of detecting a digital face image on digital images especially in fields of image processing, security system, digital camera control or the like, and there have been proposed various face detecting methods. As one of such face detecting methods, there has been proposed a face detecting method in which a face image on digital images is detected by determining whether the image in the sub-window is an image including a face by the use of a detector while controlling the sub-windows on the digital images, for instance, in S. Lao et al., “Fast Omni-Directional Face Detection”, MIRU2004, pp. II271-II276, July 2004 and U.S. Patent Application Publication No. 20020102024.

The face image includes a plurality of kinds corresponding in number to the number of orientations of the face to be detected, such as a profile portrait (a face in profile), full face portrait (a full face) and an oblique portrait (an oblique face), and features on the image differ by the kind. Accordingly, when two or more portraits different from each other in orientation of the face are to be detected together on object images, different detectors are generally employed according to the orientations of the face to be detected. For example, for determining a full face portrait, detectors which has learned features of the full face portrait with a plurality of sample images representing a full face are employed, for determining a profile portrait, detectors which has learned features of the face in profile with a plurality of sample images representing a face in profile are employed and, for determining an oblique portrait, detectors which has learned features of the oblique face with a plurality of sample images representing an oblique face are employed.

Accordingly, when orientations of the detected faces are to be known, or when only face images in a particular orientation are to be detected, the orientations of the face must be divided in a plurality of stages according to the resolution in the orientation of the face to be detected and a detector must be prepared for each of the orientations.

However, there is a problem that in the method where a detector is prepared for each of the orientations, the determining processing must be carried out by the use of number of detectors, one for each of the orientations of the face, which adds to the processing time.

### SUMMARY OF THE INVENTION

In view of the foregoing observations and description, the primary object of the present invention is to provide a method of and a system for identifying the orientation of a face in a relevant digital face image which can identify the orientation of the face in a short time and a computer program for the method.

Another object of the present invention is to provide a method of and a system for determining whether the relevant digital image is a face image and identifying the orientation of the face which can determine the same and identify the same in a short time and a computer program for the method.

In accordance with the present invention, there is provided a face orientation identifying method characterized in the steps of calculating an index representing the probability that an input image is a face image including a face oriented in a predetermined orientation for each of different predetermined orientations on the basis of a feature value of the input image including a face and identifying the orientation of the face included in the input image on the basis of the ratio of the indexes which have been calculated for the different predetermined orientations.

In the face orientation identifying method in accordance with the present invention, the step of calculating the index may be a step of calculating the index by the use of an index calculator which has learned features of the face oriented in the orientation to be calculated with a plurality of sample images representing a face oriented in the orientation to be calculated for each of the different predetermined orientations.

In the face orientation identifying method in accordance with the present invention, the different predetermined orientations may be <a front, a left side and a right side> or <an obliquely right side and an obliquely left side>.

In accordance with the present invention, there is provided a face determining method characterized in the steps of calculating an index representing the probability that an input image is an image including a face oriented in a predetermined orientation for each of different predetermined orientations on the basis of a feature value of the input image and determining whether the input image is an image including a face on the basis of the sum of the indexes which have been calculated for the different predetermined orientations and identifying the orientation of the face included in the input image on the basis of the ratio of the indexes which have been calculated for the different predetermined orientations when it has been determined that the input image is an image including a face.

In the face determining method in accordance with the present invention, the step of calculating the index may be a step of calculating the index by the use of an index calculator which has learned features of the face oriented in the orientation to be calculated with a plurality of sample images representing a face oriented in the orientation to be calculated for each of the different predetermined orientations.

In the face determining method in accordance with the present invention, the different predetermined orientations may be <a front, a left side and a right side> or <an obliquely right side and an obliquely left side>.

In accordance with the present invention, there is provided a face orientation identifying system characterized by an index calculating means which calculates an index representing the probability that an input image is oriented in a predetermined orientation for each of different predetermined orientations on the basis of a feature value of the input image including a face and a face orientation calculating means which identifies the orientation of the face included in the input image on the basis of the ratio of the indexes which have been calculated for the different predetermined orientations.

In the face orientation identifying system in accordance with the present invention, the index calculating means may be a means for calculating the index by the use of an index calculator which has learned features of the face oriented in the orientation to be calculated with a plurality of sample images representing a face oriented in the orientation to be calculated for each of the different predetermined orientations.

In the face orientation identifying system in accordance with the present invention, the different predetermined orientations may be <a front, a left side and a right side> or <an obliquely right side and an obliquely left side>.

In accordance with the present invention, there is provided a face determining system characterized by an index calculating means which calculates an index representing the probability that an input image is an image including a face oriented in a predetermined orientation for each of different predetermined orientations on the basis of a feature value of the input image and a face determining means which determines whether the input image is an image including a face on the basis of the sum of the indexes which have been calculated for the different predetermined orientations and identifies the orientation of the face included in the input image on the basis of the ratio of the indexes which have been calculated for the different predetermined orientations when it has been determined that the input image is an image including a face.

In the face determining system in accordance with the present invention, the index calculating means may calculates the index by the use of an index calculator which has learned features of the face oriented in the orientation to be calculated with a plurality of sample images representing a face oriented in the orientation to be calculated for each of the different predetermined orientations.

In the face determining system in accordance with the present invention, the different predetermined orientations may be <a front, a left side and a right side> or <an obliquely right side and an obliquely left side>.

In accordance with the present invention, there is provided a first computer program which causes a computer to function as a face orientation identifying system by causing the computer to function as an index calculating means which calculates an index representing the probability that an input image is oriented in a predetermined orientation for each of different predetermined orientations on the basis of a feature value of the input image including a face and a face orientation calculating means which identifies the orientation of the face included in the input image on the basis of the ratio of the indexes which have been calculated for the different predetermined orientations.

In the first computer program in accordance with the present invention, the index calculating means may calculates the index by the use of an index calculator which has learned features of the face oriented in the orientation to be calculated with a plurality of sample images representing a face oriented in the orientation to be calculated for each of the different predetermined orientations.

In the first computer program in accordance with the present invention, the different predetermined orientations may be <a front, a left side and a right side> or <an obliquely right side and an obliquely left side>.

In accordance with the present invention, there is provided a second computer program which causes a computer to function as a face determining system by causing the computer as an index calculating means which calculates an index representing the probability that an input image is an image including a face oriented in a predetermined orientation for each of different predetermined orientations on the basis of a feature value of the input image and a face determining means which determines whether the input image is an image including a face on the basis of the sum of the indexes which have been calculated for the different predetermined orientations and identifies the orientation of the face included in the input image on the basis of the ratio of the indexes which have been calculated for the different predetermined orientations when it has been determined that the input image is an image including a face.

In the second computer program in accordance with the present invention, the index calculating means may calculates the index by the use of an index calculator which has learned features of the face oriented in the orientation to be calculated with a plurality of sample images representing a face oriented in the orientation to be calculated for each of the different predetermined orientations.

In the second computer program in accordance with the present invention, the different predetermined orientations may be <a front, a left side and a right side> or <an obliquely right side and an obliquely left side>.

In this invention, “orientation of a face” means an orientation corresponding to the direction in which the neck is swung.

As the index calculator, those which have learned by the technic of a so-called machine learning such as a “Boosting” technic, especially an “AdaBoost” learning algorithm are conceivable.

As a resultant thing which has learned by the machine learning technic, a detector which determines whether a relevant image is a face image including a face is well known. Generally the detector calculates an index representing the probability that a relevant image is a face image on the basis of a feature value of the relevant image and determines whether the relevant image is a face image on the basis of a comparison of the calculated index with a threshold value. Accordingly, the index calculator of the present invention is conceivable as an index calculating part of the detector.

In accordance with the method of and the system for identifying the face orientation and the first computer program for the purpose of the present invention, since the index representing the probability that the input image is a face image including a face oriented in the predetermined orientation is calculated for each of different predetermined orientations, and since the orientation of the face is identified on the basis of the ratio of the indexes which have been calculated for the different predetermined orientations, orientation of the face can be identified by only a simple evaluation of the plurality of indexes limited in number, whereby the orientation of the face in the relevant digital face image can be finely identified in a short time.

Further, in accordance with the method of and the system for determining the face and the second computer program for the purpose of the present invention, since the index representing the probability that an input image is an image including a face oriented in a predetermined orientation is calculated for each of different predetermined orientations on the basis of a feature value of the input image and determining whether the input image is an image including a face on the basis of the sum of the indexes which have been calculated for the different predetermined orientations, the information on the probability that the input image is an image including a face and on the orientation of the face included in the input image can be reflected on the index by the components corresponding to the faces of the different orientations irrespective of the orientation of the face, and since whether the input image is an image including a face is determined on the basis of the sum of the indexes which have been calculated for the different predetermined orientations and at the same time, the orientation of the face included in the input image is identified on the basis of the ratio of the indexes which have been calculated for the different predetermined orientations when it has been determined that the input image is an image including a face, orientation of the face can be identified by only a simple evaluation of the plurality of indexes limited in number, whereby whether the relevant digital image is a face image can be determined and the orientation of the face in the relevant digital face image can be finely identified in a short time.

### BRIEF DESCRIPTION OF THE DRAWINGS

FIG. 1 is a block diagram showing the arrangement of the face detecting system,

FIG. 2 is a view showing steps of making the object image have a multiple resolution,

FIG. 3 is a view showing an example of the conversion curve employed in normalizing the whole,

FIG. 4 is a view showing a concept of the local normalization,

FIG. 5 is a view showing a flow of the local normalization,

FIG. 6 is a block diagram showing the arrangement of the first and second determiner groups,

FIG. 7 is a view for describing the calculation of the feature value in the weak determiner,

FIG. 8 is a flow chart showing the learning method of the determiner,

FIG. 9 is a sample face image normalized so that the eye position is brought to a predetermined position,

FIG. 10 is a view showing the method of deriving a histogram of the weak determiner,

FIG. 11A is a part of the flow chart showing the processing to be carried out by the face detecting system,

FIG. 11B is the other part of the flow chart showing the processing to be carried out by the face detecting system,

FIG. 12 is a view showing an example of the correspondence between the score calculated by the determiner and determination of whether the input image is a face image and the correspondence between the score calculated by the determiner and orientation of the face identified, and

FIG. 13 is a view for describing the relation between the switching of the resolution of the image to be detected and the movement of the sub-window on the image thereof.

### DESCRIPTION OF THE PREFERRED EMBODIMENT

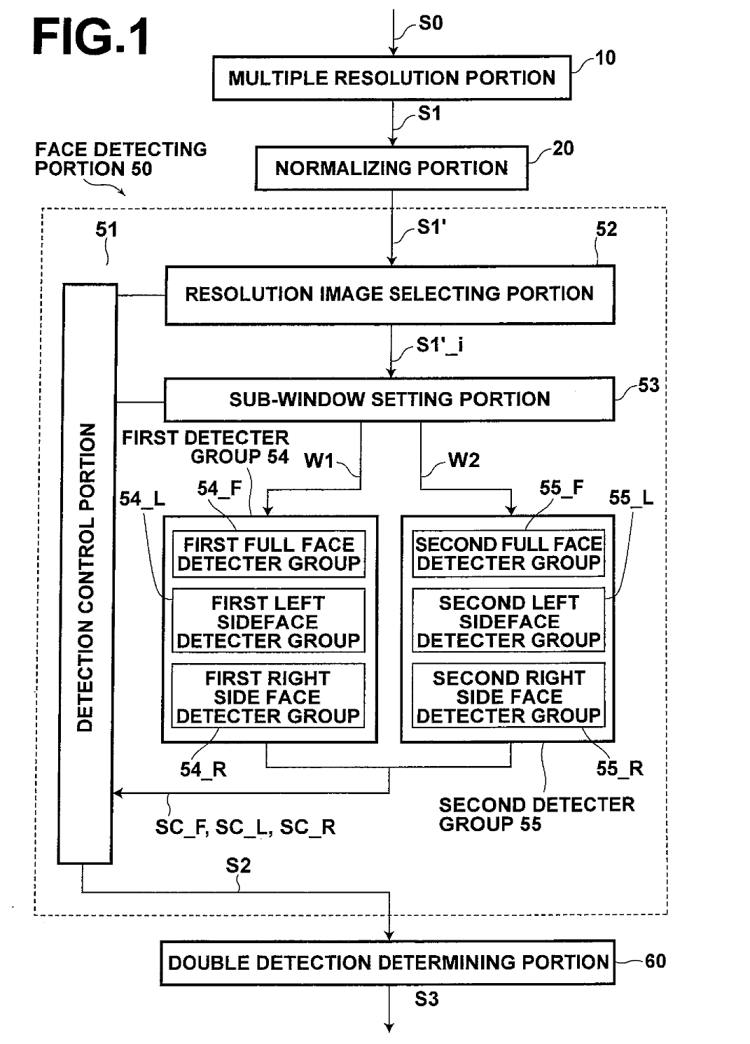

FIG. 1 is a block diagram showing in brief the arrangement of the face detecting system 1 to which the present invention is applied. The face detecting system 1 detects a digital face image including therein a face irrespective of the orientation or the inclination of the face. In this invention, “orientation of a face” means an orientation corresponding to the direction in which the neck is swung and “inclination of a face” means an inclination (rotational position) in the direction of in-plane (in the plane of the image).

The face detecting system 1 employs a technic using a determiner module generated by the machine learning with a sample image, which is said to be excellent especially in the detecting accuracy and the robust. In this technic, a determiner module is caused to learn the feature of the face by the use of face image sample groups comprising a plurality of different face image samples which have substantially the same orientations and inclination of the faces and non-face image sample groups comprising a plurality of different non-face image samples which are known not to be the face images, to prepare a determiner module which is capable of determining whether an image is an image of a face which has predetermined orientation and inclination, and fraction images are cut in sequence from the image to be detected for a face (to be referred to as “the object image”, hereinbelow) to determine with the determiner module whether each of the fraction images is a face image, whereby the face image on the object image is detected.

This technic is disadvantageous in that since whether each of the fraction images is a face image is determined, the processing is increased to a vast amount when it is intended to make an accurate detection from the beginning, which requires a long time in detection of a face image. Accordingly, here, in order to improve efficiency of the determination, a relatively rough face detection is carried out on the object image (for instance, positions of the fraction images to be cut in sequence are thinned) to extract prospective face images, and a fine detection is carried out on the prospective face images to determine whether the prospective face images are real face images.

As shown in FIG. 1, the face detecting system 1 comprises a multiple resolution portion 10, a normalizing portion 20, a face detecting portion 50 and a double detection determining portion 60. The face detecting portion 50 further comprises a detection controlling portion (face detecting means) 51, a resolution selecting portion 52, sub-window setting portion 53, a first determiner group 54 and a second determiner group (index calculating means) 55.

The multiple resolution portion 10 makes the input object image So have a multiple resolution to obtain a resolution image group S1 comprising a plurality of images S1_1, S1_2, . . . S1_n (referred to as “the resolution images”, hereinbelow). That is, the multiple resolution portion 10 converts the resolution (the image size) of the object image S to a predetermined resolution, thereby normalizing the object image S to a predetermined resolution, an image having a size of a rectangle, for instance, of 416 pixels in the shorter side and obtaining a normalized input image So′, and obtains the resolution image group S1 by generating the plurality of the resolution images different in the resolution by carrying out a resolution conversion on the basis of the normalized input image So′.

The reason why such a resolution image group is generated is that since though the size of the face included in the object is generally unknown, the size of the face (image size) to be detected is fixed to a predetermined size in conjunction with the method of generating a determiner to be described later, it is necessary to cut out the fraction images of a predetermined size while shifting the position on the images different in resolution and to determine whether each of the fraction images is a face image.

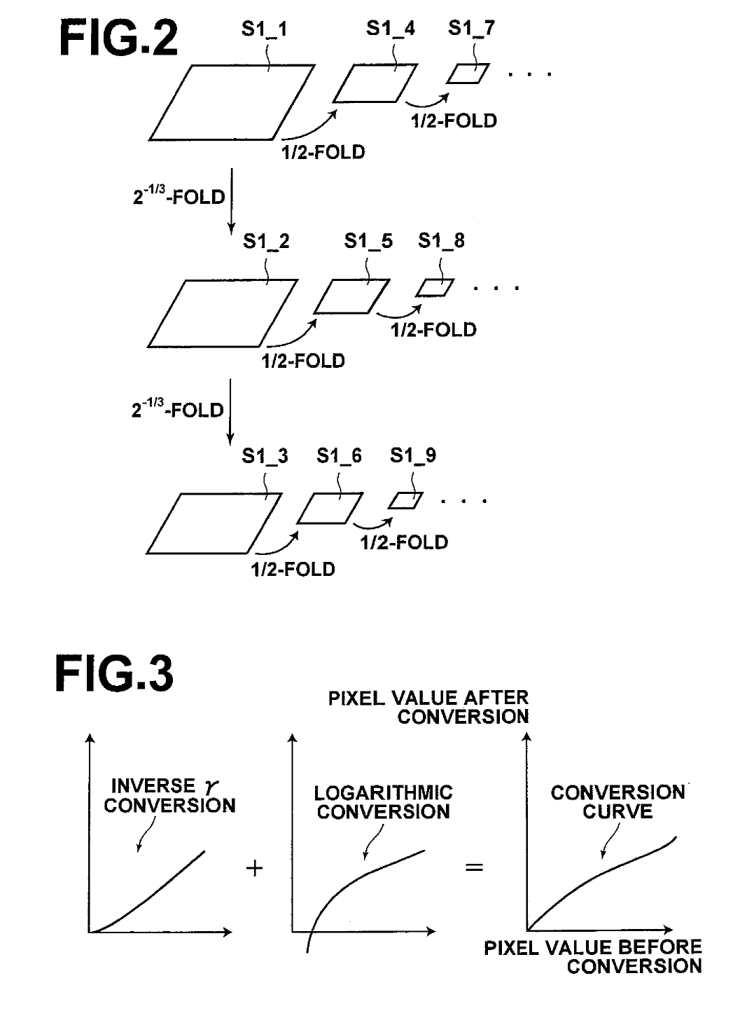

FIG. 2 is a view showing steps of making the object image have a multiple resolution. In making the object image have a multiple resolution, that is, generation of the resolution image group, specifically, as shown in FIG. 2, the processing of making the normalized object image be a resolution image S1_1 which makes a reference resolution image, previously generating a resolution image S1_2 (2^{-1/3}-fold of the resolution image S1_1 in size) and a resolution image S1_3 (2^{-1/3}-fold of the resolution image S1_2 in size, 2^{-2/3}-fold of the reference resolution image S1_1 in size), subsequently reducing in size the resolution images S1_1, S1_2 and S1_3 to ½ of the original size, and further reducing them to ½ in size is repeated to generate resolution images in a predetermined number. By this, ½ reduction where it is not necessary an interpolation of the pixel value representing brightness is employed as a main processing, and a plurality of images which are reduced in size by 2^{-1/3}-fold of the reference resolution image by 2^{-1/3}-fold of the reference resolution are generated at a high speed. For example, when it is assumed that the resolution image S1_1 has a size of rectangle of 416 pixels in the shorter side, the resolution images S1_2 and S1_3, . . . have sizes of a rectangle of 330 pixels, 262 pixels, 208 pixels, 165 pixels, 131 pixels, 104 pixels, 82 pixels, 65 pixels, . . . in the shorter side and a plurality of images which are reduced in size by 2^{-1/3}-fold of the reference resolution image by 2^{-1/3}-fold of the reference resolution are generated. Since having a strong tendency to hold the feature of the original image pattern, the images generated without the interpolations of the pixel values are preferred in that an improvement of accuracy in the face detection processing can be expected.

The normalizing portion 20 carries out a whole normalization and a local normalization on each of the resolution images so that the resolution images come to be suitable for the face detection to be executed later and obtains a resolution image group S1′ comprising a plurality of normalized resolution images S1′_1, S1′_2, . . . S1′_n.

The whole normalization will be described first. The whole normalization is a process to convert the pixel values of the whole resolution image according to a conversion curve which causes the pixel values of the whole resolution image to approach the logarithmic value thereof in order to cause the contrast of the resolution image to approach a level suitable for the face detection, that is, for deriving performance of the determiner to be described later.

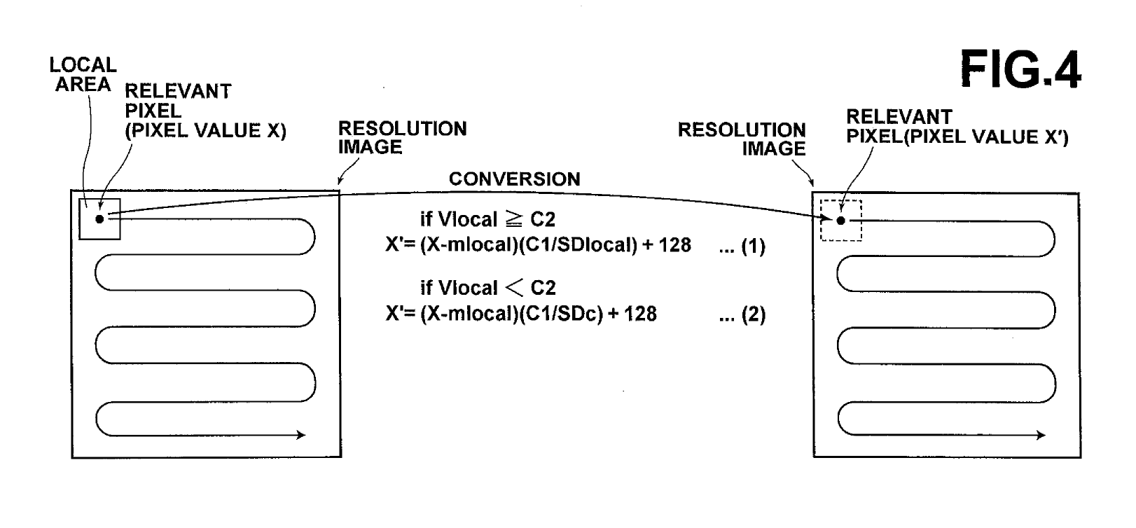

FIG. 3 is a view showing an example of the conversion curve employed in the whole normalization. As the whole normalization, a processing of converting the pixel values of the whole resolution image according to a conversion curve (lookup table) such as shown in FIG. 3 where a so-called inverse γ-conversion (raising to 2.2-th power) in the sRGB space is carried out on the pixel values and then the logarithmic values of the converted pixel values are further taken is conceivable. This is on the basis of the following reasons.

The light intensity I observed as an image is generally represented as a product of the reflectance R of the object and the intensity L of the light source (I=R×L). Accordingly, when the intensity L of the light source changes, the light intensity I observed as an image also changes but if the reflectance of the object can only be evaluated, the face detection can be carried out at high accuracy without depending on the intensity L of the light source, that is, being affected by lightness of the image.

When it is assumed that the intensity of the light source is L, the intensity observed from a part of the object where the reflectance is R1 is I1 and the intensity observed from a part of the object where the reflectance is R2 is I2, the following formula holds in the space where the logarithmic values are taken.
log(I1)−log(I2)=log(R1×L)−log(R2×L)=log(R1)+log(L)−(log(R2)+log(L))=log(R1)−log(R2)=log(R1/R2)

That is, conversion of pixel values in an image to the logarithmic values means conversion to a space where ratios in the reflectance are expressed as differences between the same. In such a space, it is possible to evaluate only the reflectance of an object which does not depend upon the intensity L of the light source. In other words, contrasts (difference between pixel values itself, here) which differ depending upon the lightness in the image can be uniformed.

On the other hand, the color space of an image obtained by an instrument such as a general digital still camera is sRGB. The sRGB is a color space of the international standard where color and chroma are defined and integrated in order to integrate the difference in color reproduction among instruments, and in this color space, the pixel values of images are values obtained by raising input brightness by 1/γout (=0.45)-th power in order to make feasible to suitably reproduce color in image output instruments where γ value (γout) is 2.2.

Accordingly, by carrying out on the pixel values of the whole image a so-called inverse γ conversion, that is, according to a conversion curve for raising the pixel values by 2.2-th power and then taking logarithmic values thereof, an object which does not depend upon the intensity of the power source can be suitably evaluated only by the reflectance.

Such whole normalization is in other words to convert the pixel values of the whole image according to a conversion curve for converting a specific color space to a color space having other characteristics.

When such processing is carried out on the object image to be detected, the contrast of the object image which differs from the image to image according to the lightness of the image can be uniformed and face detecting accuracy is improved. The whole normalization is characterized in that the processing time is short though the result is apt to be affected by oblique rays, background or input modality.

The local normalization will be described next. The local normalization is a process to suppress unevenness in contrast of the local areas in the resolution image. That is, first and second brightness gradation conversion processes are carried out on the resolution image. The first brightness gradation conversion process is carried out on the local area where the degree of dispersion of the pixel values representing the brightness is not lower than a predetermined level and causes the degree of dispersion to approach a certain level higher than the predetermined level. The second brightness gradation conversion process is carried out on the local area where the degree of dispersion of the pixel values representing the brightness is lower than said predetermined level and suppresses the degree of dispersion to a level lower than said certain level. The local normalization is characterized in that the processing time is long though the result is less apt to be affected by oblique rays, background or input modality.

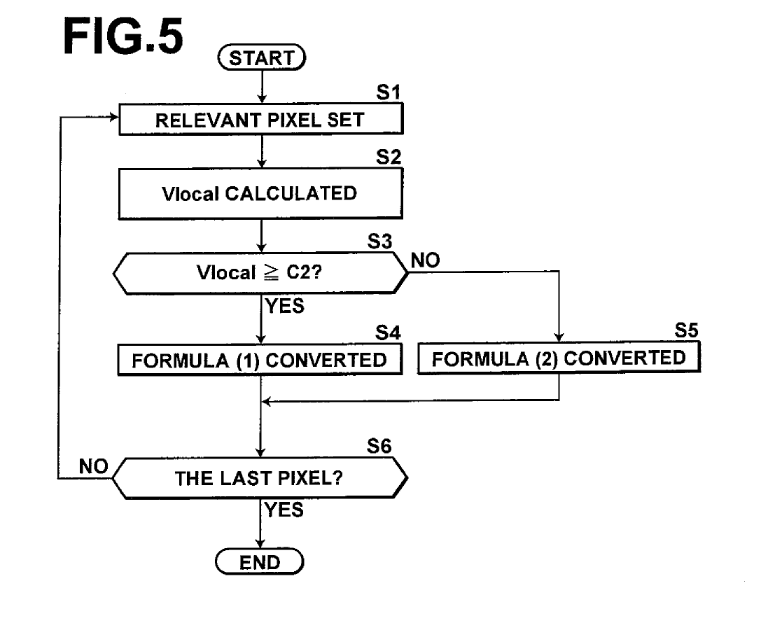

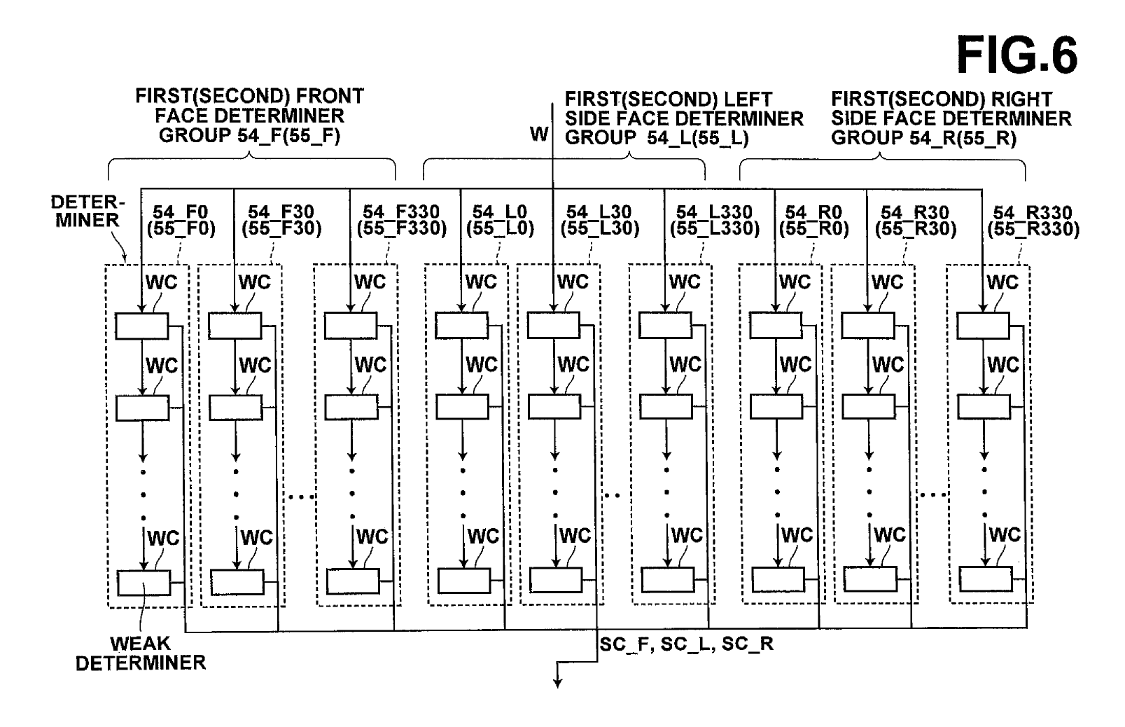

FIG. 4 is a view showing a concept of the local normalization, and FIG. 5 is a view showing a flow of the local normalization. The following formulae (1) and (2) are formulae of brightness gradation conversion to be carried out on the pixel values for the local normalization.
if Vlocal≧C2
X′=(X−mlocal)(C1/SDlocal)+128 (1)
if Vlocal<C2
X′=(X−mlocal)(C1/SDc)+128 (2)
wherein X, X′, mlocal, Vlocal, SDlocal, (C1×C1), C2 and SDc respectively represent the pixel value of the relevant pixel, the pixel value of the relevant pixel after conversion, the mean of the pixel values in the local area about the relevant pixel, the dispersion of the pixel values in the local area, the standard deviation of the pixel values in the local area, the reference value corresponding to said certain level, a threshold value corresponding to said predetermined level and a predetermined constant. In this embodiment, the number of gradation of the brightness is in 8 bits and the value which the pixel value can take is from 0 to 255.

As shown in FIG. 5, one pixel in a fraction image W2 is set as a relevant pixel (step S1), the dispersion Vlocal of the pixel values in the local areas of a predetermined size, e.g., 11×11 pixel size, about the relevant pixel is calculated (step S2), and whether the dispersion Vlocal is not lower than a threshold value C2 corresponding to said predetermined level is determined (step S3). When it is determined in step S3 that the dispersion Vlocal is not lower than the threshold value C2, the gradation conversion where the difference between the pixel value X of the relevant pixel and the mean value mlocal is reduced as the dispersion Vlocal is larger than the reference value C1×C1 corresponding to said certain level and increased as the dispersion Vlocal is smaller than the reference value C1×C1 is carried out according to formula (1) as the first brightness gradation conversion process (step S4). When it is determined in step S3 that the dispersion Vlocal is lower than the threshold value C2, the gradation conversion is carried out according to formula (2) which does not depend upon the dispersion Vlocal as the second brightness gradation conversion process (step S5). Then whether the relevant pixel which has been set in Step S1 is the last one is determined (step S6). When it is determined in step S6 that the relevant pixel is not the last one, the processing returns to step S1 and the next pixel in the same fraction image is set as a relevant pixel. When it is determined in step S6 that the relevant pixel is the last one, the local normalization on the fraction image is ended. By repeating the processing shown in steps S1 to S6, the local normalization can be wholly carried out on the resolution image.

The predetermined level may be changed according to the brightness of the whole local area or a part of the local area. For example, in the normalization described above, where gradation conversion is carried out on a relevant pixel, the threshold value C2 may be changed according to the pixel value of the relevant pixel. That is, the threshold value C2 corresponding to the predetermined value may be higher when the brightness of the relevant pixel is relatively high while may be lower when the brightness of the relevant pixel is relatively low. By this, even a face which exists at a low contrast (with the dispersion of the pixel values being low) in a so-called dark area where the brightness is low can be correctly normalized.

Here assuming that the inclination of the face to be detected is included in a twelve inclinations set by rotating a face by 30° about the vertical direction of the input image S0 in a plane of the input image S0, the order of inclination of the face to be detected has been set in advance as an initialization. For example, when expressed in the clockwise direction about the vertical direction of the input image S0, the order is 0°, 330°, 30° (three directions inclined upward), 90°, 60°, 120° (three directions inclined rightward), 270°, 240°, 300° (three directions inclined leftward), 180°, 150°, 210° (three directions inclined downward).

The face detecting portion 50 detects face images S2 in a predetermined number included in each of the resolution images by carrying out the face detection on each resolution image of the resolution image group S1′ normalized by the normalizing portion 20 while changing the inclination of the face to be detected in the preset order and comprises a detection controlling portion (face detecting means) 51, a resolution selecting portion 52, a sub-window setting portion 53, a first determiner group 54 and a second determiner group (index calculating means) 55 as described above.

The detection controlling portion 51 controls the other parts forming the face detecting portion 50 to carry out a sequence control in face detection. That is, the detection controlling portion 51 controls the resolution selecting portion 52, the sub-window setting portion 53, the first determiner group 54 and the second determiner group 55 in order to effect the stepwise face detection of roughly detecting each resolution image of the resolution image group S1′ for prospective face images and determining whether the prospective images are real face images, thereby detecting real face images S2, or the face inclination detection of detecting the inclination of a face in the order set by a face inclination order setting portion 40. For example, the detection controlling portion 51 instructs a selection of the resolution image at a proper timing to the resolution selecting portion 52 or instructs sub-window setting conditions under which the sub-windows are set to the sub-window setting portion 53, or switches the kind of determiners to be employed in the determiners forming the first and second determiner groups 54 and 55. The sub-window setting conditions include which determiner group is to be employed in the determination (rough/fine detecting mode) as well as the range of the image in which the sub-window is to be set, and the intervals at which the sub-window is moved (roughness of the detection).

Further, the detection controlling portion 51 has a function of determining whether a fraction image is a face image on the basis of the sum of the scores calculated by a plurality of determiners which are the same in the inclination of the face to detect and are different in the orientation of the face to detect or determining the orientation of the face on the basis of the ratio of such scores.

The resolution selecting portion 52 selects a resolution image to be employed in the face detection in the resolution image group S1′ in sequence in the order in which the size becomes smaller (or the resolution becomes rougher). Since the technic of this embodiment is a technic of detecting a face in the input image S0 by determining whether the fraction images W1 cut out from each resolution images in the same size are face images, the resolution selecting portion 52 sets the size of the face to be detected in the input image S0 while changing the same every time, and may be said to be equivalent to that which sets the size of the face to be detected while changing the same from the small to the large.

The sub-window setting portion 53 sets in sequence the sub-window for cutting out the fraction image W1 which is to be determined whether it is a face image in the resolution image selected by the resolution selecting portion 52 while shifting the position thereof under the sub-window setting conditions set by the detection controlling portion 51.

For example, when the rough detection described above is to be effected, a sub-window for cutting out fraction images W1 of a predetermined size, e.g., a 32×32 pixel size are set in sequence while moving the sub-window by a predetermined number of pixels, for instance, by five pixels, and input the cut out fraction images W1 into the first determiner group 54. Since each of the determiners forming the determiner group calculates the score representing the probability that a certain image is a face image having a predetermined inclination and a predetermined orientation of the face as described later, face images including a face in all the orientations can be determined by evaluating the sores. When further fine detection is to be carried out on the above prospective face images, a sub-window for cutting out fraction images W2 are set in sequence while moving the sub-window at shorter intervals, for instance, by one pixel limiting to a vicinity of a predetermined size including the prospective face image in the resolution images and the fraction images (input image) W2 are cut out in the same manner as described above and input into the second determiner group 55.

Though the first and second determiner groups 54 and 55 are basically formed by a plurality of kinds of the determiners which determines whether the fraction image W1 or W2 is a face image, this determiner has a function of a score calculator (index calculator) which calculates a probability that the fraction image W1 or W2 is a face image including a face oriented in the predetermined orientation. In this embodiment, the first and second determiner groups 54 and 55 are employed as the score calculator group.

The first determiner group 54 comprises a plurality of kinds of the determiners which calculate a probability that the fraction image W1 is a face image including a face oriented in the predetermined orientation at a relatively high speed and is employed to roughly detect the prospective face images in the resolution images. On the other hand, the second determiner group 55 comprises a plurality of kinds of the determiners which calculate a probability that the fraction image W2 is a face image including a face oriented in the predetermined orientation at a relatively high accuracy and is employed to determine whether the prospective face image is a real face image S2.

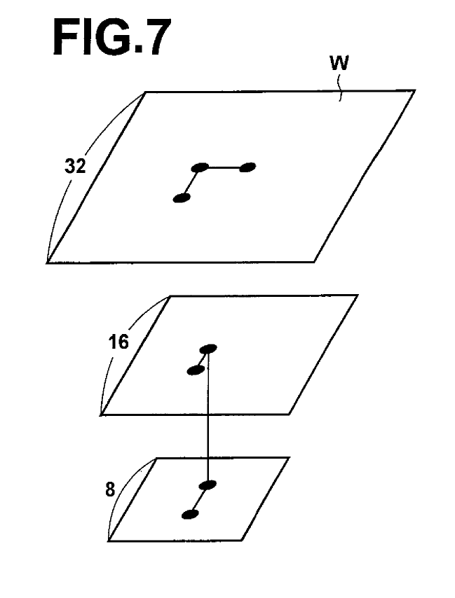

FIG. 6 is a view showing the arrangement of the first and second determiner groups 54, 55. As shown in FIG. 6, in the first determiner group 54, a plurality of determiner groups which are different in faces to determine, that is, a first full face determiner group 54_F for mainly detecting full face images, a first left side face determiner group 54_L for mainly detecting left side face images, and a first right side face determiner group 54_R for mainly detecting right side face images, are connected in parallel. Further, these three kinds of determiner groups 54_F/, 54_L and 54_R respectively comprise determiners which correspond to a total twelve orientations which are different from each other in faces to determine by 30° about the vertical direction of the fraction image. That is, the first full face determiner group 54_F comprises a determiner 54_F0, 54_F30, . . . 54_F330, the first left side face determiner group 54_L comprises a determiner 54_L0, 54_L30, . . . 54_L330 and the first right side face determiner group 54_R comprises a determiner 54_R0, 54_R30, . . . 54_R330.

As shown in FIG. 6, in the second determiner group 55, a plurality of determiner groups which are different in faces to determine, that is, a second full face determiner group 55_F for mainly detecting full face images, a second left side face determiner group 55_L for mainly detecting left side face images, and a second right side face determiner group 55_R for mainly detecting right side face images, are connected in parallel as in the first determiner group. Further, these three kinds of determiner groups 55_F/, 55_L and 55_R respectively comprise determiners which correspond to a total twelve orientations which are different from each other in faces to determine by 30° about the vertical direction of the fraction image as in the first determiner group. That is, the second full face determiner group 55_F comprises a determiner 55_F0, 55_F30, . . . , 55_F330, the second left side face determiner group 55_L comprises a determiner 55_L0, 55_L30, . . . , 55_L330 and the second right side face determiner group 55_R comprises a determiner 55_R0, 55_R30, . . . , 55_R330.

As shown in FIG. 6, each of the above described determiners has a cascade structure where a plurality of weak determiners WC are linearly coupled, and the weak determiners calculate at least one feature value concerning to the pixel value distribution of the fraction image W (W1 or W2), and the determiner calculates a score representing a probability that the fraction image W is a face image including a face oriented in the predetermined orientation by the use of the feature value.

In either of the first and second determiner groups 54 and 55, the determinable orientation of the face is of the three kinds, the full face, the left side face and the right side face. However, they may be a determiner which can determine an obliquely right side face or an obliquely left side face.

The double detection determining portion 60 carries out processing of integrating the face images which represent the same face or have been detected double in the face images detected in each resolution image of the first resolution image group S1′ on the basis of the information on the position of the real face images S2 detected by the face detecting portion 50 and outputs real face images S3 detected in the input image S0. Though depending on the method of learning, since the determiner has a margin in the size of the detectable face with respect to the size of the fraction image W, images representing the same face can be sometimes detected double.

The arrangement of each of the determiners forming the determiner group, the flow of processing in the determiner and the method of learning of the determiner will be described, hereinbelow.

The determiner comprises, as shown in FIG. 6, a plurality of weak determiners WC which have been selected to be effective to the determination from a number of weak determiners WC by a learning to be described later. A weak determiner has a feature value calculating algorithm natural to the weak determiner and a score table (own histogram to be described later), and each weak determiner calculates the feature value from the fraction image W and calculates a score representing the probability that the fraction image W is a face image including a face oriented in a predetermined orientation and inclined at a predetermined inclination. The determiner sums up all the scores obtained by these weak determiners WC and calculates a final score representing the probability that the fraction image W is a face image including a face oriented in a predetermined orientation and inclined at a predetermined inclination.

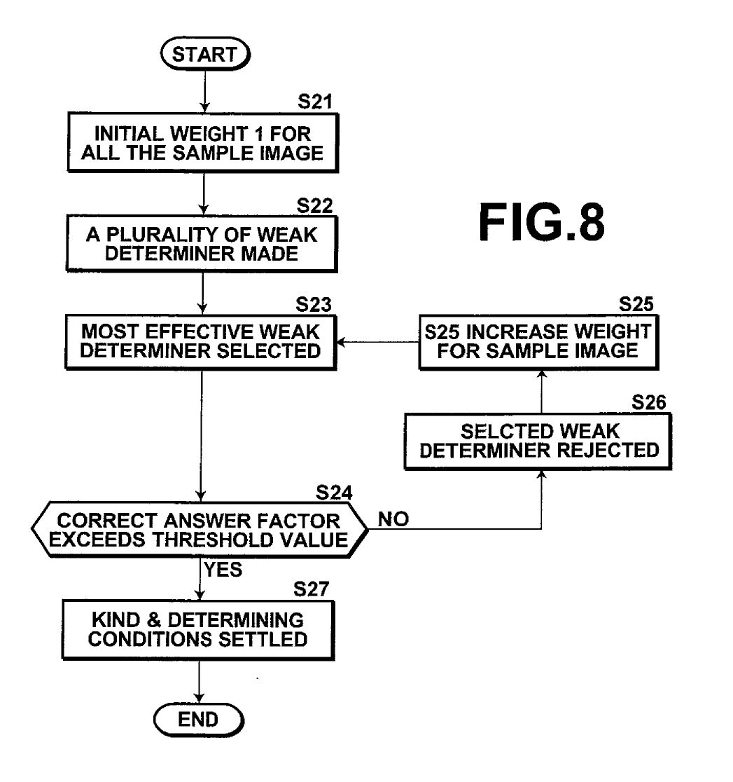

When the fraction image W is input into the determiner, the feature value x is calculated in a first weak determiner WC. For example, as shown in FIG. 7, an image 16×16 in pixel size and an image 8×8 in pixel size which are reduced in pixel size are obtained by carrying out a four vicinity pixel averaging (the image is divided into a plurality of blocks by every pixel size of 2×2, and the average of the pixel values of the four pixels in each block is taken as the pixel value of the pixel corresponding to the bock) on the fraction image of the predetermined size, e.g., 32×32 in pixel size, and predetermined two points set in the plane of three images, the two images plus the original image, are taken as one pair, and the difference in the pixel value (brightness) between the two points of each pair forming one pair group comprising a plurality of pairs is calculated and a combination of the differences is taken as the feature value. The predetermined two points of each pair is, for instance, two points vertically arranged in a row or two points horizontally arranged in a row so that a density feature of the face in the image is reflected. Then a value corresponding to the combination of the differences which is the feature value is calculated as x. Then a first score of a probability that the fraction image W is a face image representing a face which is to detect (For example, in the case of the determiner 54_F30, an image of a face whose orientation is front and whose inclination is rotation at 30°) is obtained from the predetermined score table (own histogram) according to the value x. Then flow is shifted to a process by a second weak determiner WC and a second score is calculated on the basis of a feature value calculation algorithm and a score table natural to the second weak determiner WC. All the weak determiners WC are caused to calculate the sore, and the score obtained by summing up all such scores forms the final score of the determiner.

The method of learning (generation) of the determiner will be described, hereinbelow.

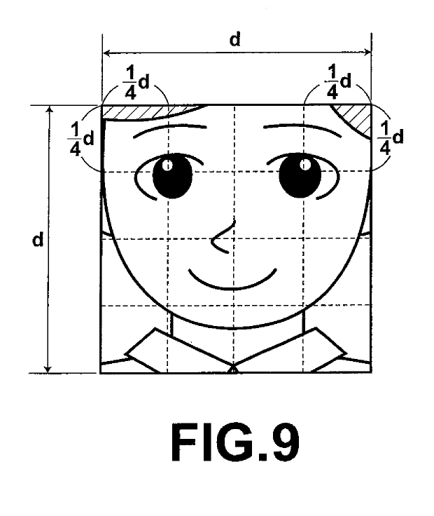

FIG. 8 is a flow chart showing the learning method of the determiner. For learning of the determiner, a plurality of sample images which has been normalized to a predetermined size, for instance, 32×32 pixel size, and which has been processed in the same manner as the normalization by the normalizing portion 20 described above. As the sample images, a face sample image group comprising a plurality of different images which have been known to include a face, and a non-face sample image group comprising a plurality of different images which have been known not to include a face are prepared.

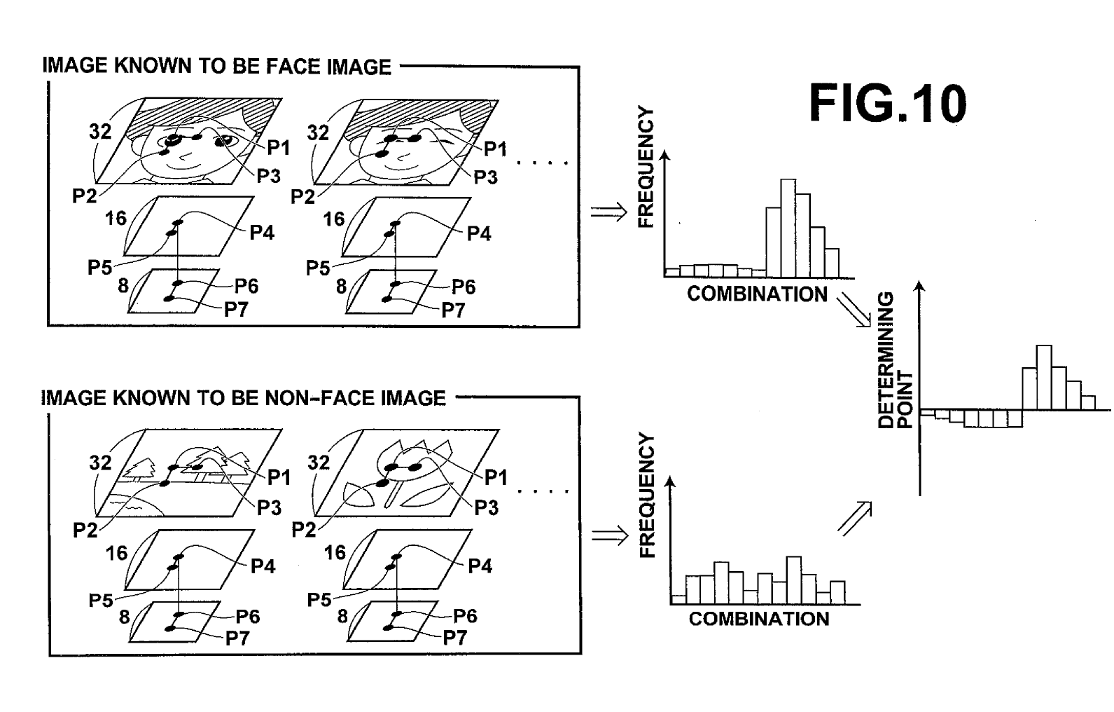

The face sample image group employs a plurality of variations obtained by rotating 3° by 3° in the range of ±15° in a plane sample images which are obtained by stepwise reducing the size of one face sample image 0.1-fold by 0.1-fold vertically and/or horizontally in the range of 0.7- to 1.2- fold. At this time, the face sample image is normalized so that the eyes are brought to a predetermined position and the above rotation and reduction in size are effected on the basis of the position of the eyes. For example, in the case of the sample image of d×d size, as shown in FIG. 9, the size and position of the face are normalized so that the left and right eyes are respectively brought to d/4 inward from the left uppermost edge of the sample image and from the right uppermost edge of the sample image and the above rotation and reduction in size are effected about the intermediate point of the eyes.

The sample images are allotted with weights or the degree of importance. First the initial weights on all the sample images are equally set to 1 (step S21)

Then with predetermined two points set in the planes of the sample image and the reduced image thereof taken as one pair, a plurality of pair groups each comprising a plurality of pairs are set. For each of the plurality of pair groups, the weak determiner is made (step S22). Each of the weak determiners provides a reference on the basis of which a face image and a non-face image is determined by the use of a combination of the difference values in pixel values (brightness) between two points of each pair forming one pair group when a plurality of pair groups are set with predetermined two points set in the planes of the fraction image cut out by the sub-window W and the reduced image thereof taken as one pair. In this embodiment, a histogram on a combination of difference values between the two points of each of the pairs forming one pair group is employed as a base of the score table of the weak determiner.

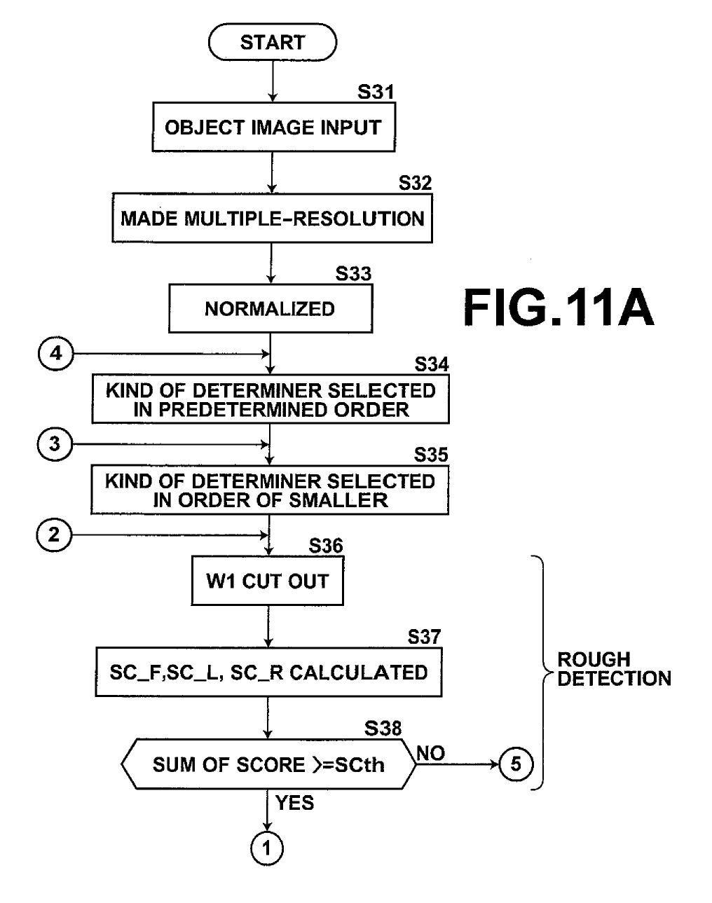

FIG. 10 shows generation of the histogram from the sample image. As shown by a sample image in the left side of FIG. 10, two points of each pair forming pair groups for making the determiner are P1-P2, P1-P3, P4-P5, P4-P6 and P6-P7 wherein, in a plurality of sample images which have been known to be a face image, a point on the center of the right eye in the sample image is represented by P1, a point on the right cheek in the sample image is represented by P2, a point on the middle of the forehead in the sample image is represented by P3, a point on the center of the right eye in the 16×16 reduced image reduced by four vicinity pixel averaging is represented by P4, a point on the right cheek in the 16×16 reduced image reduced by four vicinity pixel averaging is represented by P5, a point on the forehead in the 8×8 reduced image reduced by four vicinity pixel averaging is represented by P6 and a point on the mouth in the 8×8 reduced image reduced by four vicinity pixel averaging is represented by P7. The two points of each pair forming one pair group for making a determiner are the same in the coordinate positions in all the sample images. A combination of the difference values between two points of each pair for the above described five pairs are obtained for all the sample images which have been known to be a face image, and the histogram thereof is made. The values of a combination of the difference values can take 65536 ways per one difference value of the pixel values assuming that the number of gradation of the brightness of the image is of 16 bit gradation, though depending upon the number of gradation of the brightness of the image. And it is the number of gradation (the number of pairs), that is, fifth power of 65536 in the whole, which requires a vast number of samples and memories and a long time for learning and detection. Accordingly, in this embodiment, the difference values in the pixel values are divided in a suitable width, and quantized/n-valued (e.g., n=100). With this arrangement, the number of combinations of the difference values in the pixel values becomes fifth power of n, and the number of pieces of data representing the number of combinations of the difference values in the pixel values can be reduced.

Similarly, also for non-face sample images which have been known not to be a face image, a histogram is made. For the non-face sample images, positions corresponding to the positions of the points employed in the face sample images are employed (indicated at the same reference numerals P1 to P7). The rightmost histogram in FIG. 10 is a histogram on the basis of which the score table of the weak determiner is made and which is made on the basis of the logarithmic values of the ratio of the frequencies shown by said two histograms. Each value of the ordinate shown by the histogram of the weak determiner will be referred to as “the determining point”, hereinbelow. According to the determiner, there is a strong probability that an image which exhibits a distribution of the combination of the difference values of the pixel values corresponding to a positive determining point is a face image, and the probability becomes stronger as the absolute value of the determining point increases. Conversely, there is a strong probability that an image which exhibits a distribution of the combination of the difference values of the pixel values corresponding to a negative determining point is not a face image, and the probability becomes stronger as the absolute value of the determining point increases. In step S22, there is made a plurality of weak determiners which are in the form of the above histogram on combinations of difference in pixel values between predetermined two points on each pair of the plurality of kinds of the pair groups which can be employed in determination. Subsequently, the weak determiner the most effective in determining whether an image is a face image is selected from the weak determiners made in step S22. Selection of the most effective weak determiner is effected taking into account the weight of each sample images. In this example, the weighted correct answer factors of the weak determiners are compared and the determiner which exhibits the highest weighted correct answer factor is selected (step S23). That is, since the weights of the sample image is equally 1 in the first step S23, the weak determiner by which whether the sample image is a face image is correctly determined in the largest number is simply selected as the most effective weak determiner. On the other hand, in the second step S23 where the weights of the sample images have been updated in step S25 to be described later, sample images having a weight of 1, having a weight heavier than 1, and having a weight lighter than 1 mingle with each other, and the sample images having a weight heavier than 1 is counted more than the sample images having a weight of 1 by an amount heavier than 1 in the evaluation of the correct answer factor. With this arrangement, in the second and the following step S23, that the sample images having a heavier weight is correctly determined is emphasized more than that the sample images having a lighter weight is correctly determined.

Then whether the correct answer factor of a combination of the weak determiners selected up to the time, that is, the ratio at which the result of determining whether the sample images are a face image by the use of a combination of the weak determiners selected up to the time conforms to the real answer (the weak determiners need not be linearly connected in the learning stage), exceeds a predetermined threshold value is checked (step S24). Either the currently weighted sample image group or the equally weighted sample image group may be employed here when the correct answer factor of a combination of the weak determiner is evaluated. When the correct answer factor exceeds the predetermined threshold value, the learning is ended since the weak determiners selected up to the time can determine whether the image is a face image at a sufficiently high probability. When the correct answer factor is not larger than the predetermined threshold value, the processing proceeds to step S26 in order to select an additional weak determiner to be employed in combination of the weak determiners selected up to the time.

In step S26, in order not to be selected again the weak determiner selected in the immediate step S23, the weak determiner is rejected.

Then the weight of the sample image which has not been correctly determined whether it is a face image by the weak determiner in the immediate step S23 is increased while the weight of the sample image which has been correctly determined whether it is a face image by the weak determiner in the immediate step S23 is reduced (step S25). The reason why the weight is increased or reduced is that the images which have not been correctly determined whether they are a face image by the already selected weak determiner is emphasized so that the weak determiner which can determine whether the images are a face image is selected, whereby the effect of combination of the weak determiners is increased.

The processing is subsequently returned to step S23 and the weak determiner which is second most effective is selected on the basis of the weighted correct answer factor as described above. The kind of determiners and the determining conditions for determining whether the sample image is a face image are established (step S27) and the learning is ended when the correct answer factor to be checked exceeds the threshold value in step S24 at a time a weak determiner corresponding to a combination of the difference in the pixel value between predetermined two points on pairs forming a specific pair group is selected as a weak determiner suitable for determining whether the sample image is a face image while steps S23 to S26 are repeated. The weak determiners selected are linearly connected in the order in which the correct answer factor is higher and one determiner is formed. As for each of the weak determiners, a score table for calculating a score according to the combination of the differences in the pixel value is generated on the basis of a histogram obtained for each of the weak determiners. Histogram itself maybe used as the score table and in this case, the determining points on the histogram is the score as it is.

The determiners are thus generated by learning using face sample images and non-face sample images. In order to generate a plurality of determiners which are different in inclination and orientation of the face to be determined, face sample image groups corresponding to the inclination and orientation are prepared and learning by the use of the face sample image groups and non-face sample image groups are effected by the kind of the face sample image group.

That is, in this embodiment, three kinds, the full face, the left side face and the right side face as for the orientation of the face and twelve kinds by 30° from the rotational angle 0° to 330° to the grand total of thirty-six kinds sample images are prepared. When the determiners of the first and second determiner groups are to learn by the use of different sample images, twice the value (36×2=72) of the kinds of face sample images are to be prepared.

When the plurality of face sample image groups are obtained, the learning described above is effected by the use of the face sample image groups and the non-face sample image groups, whereby a plurality of determiners forming the first and second determiner groups 54 and 55 can be generated.

When the learning method described above is employed, the weak determiner may be any without limited to those in the form of a histogram so long as it provides a reference on the basis of which whether the sample image is a face image or a non-face image is determined by the use of a combination of the differences in pixel value between predetermined two points on the pairs forming a specific pair group, and may be, for instance, two-valued data, a threshold value or a function. Further, even the histogram representing the distribution of the difference between the two histograms shown at the center of FIG. 10 may be used.

Further, the learning method need not be limited to the above technic but the technic of machine learning such as a neural network may be employed.

The flow of processing in the face detecting system 1 will be described, hereinbelow.

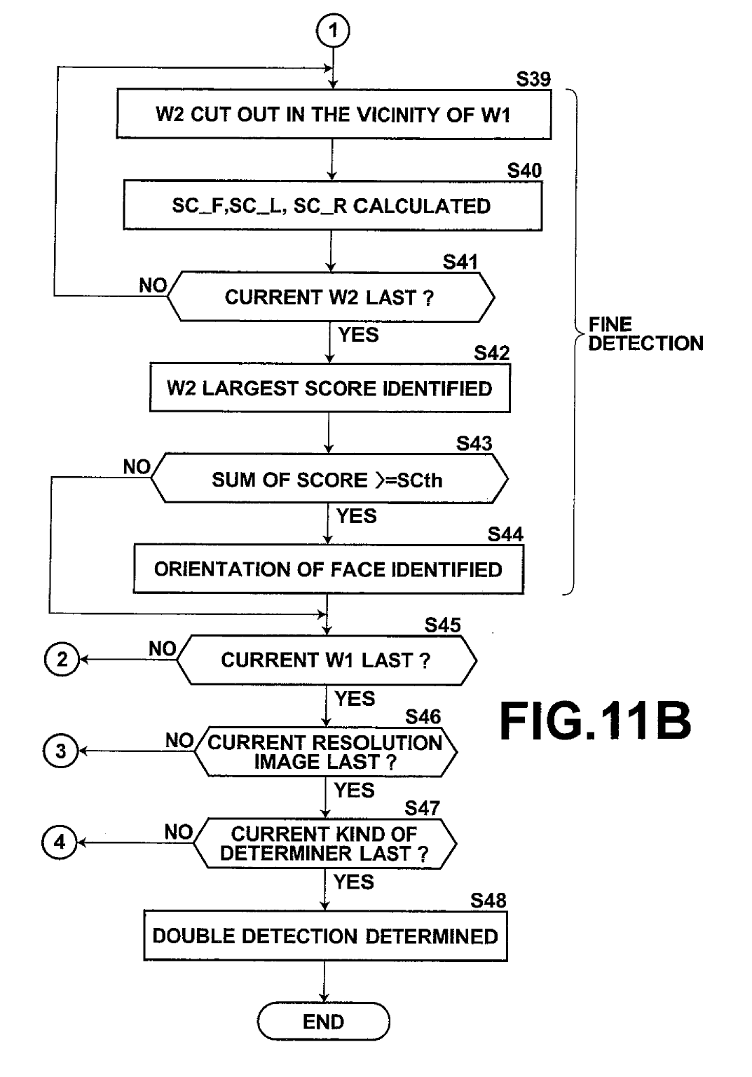

FIGS. 11A and 11B show a flow of processing in the face detecting system 1. When an object image S0 to be detected for a face is input into the face detecting system 1 (step S31), the object image S0 is supplied to the multiple resolution portion 10. An image S0′ obtained by converting the image size of the object image S0 to a predetermined image size is generated and a resolution image group S1 comprising a plurality of resolution images which are reduced in size (resolution) by 2^{-1/3}-fold of the image S0′ is generated (step S32).

Then in the normalizing portion 20, the whole normalization and the local normalization described above are carried out on the resolution images of the resolution image group S1 to obtain normalized resolution images (step S33).

In the face detecting portion 50, the kind of the determiner (the inclination of the face to detect) which is employed by the detection controlling portion 51 to calculate the score representing the probability that the fraction image W1 is a face image is selected to conform to the predetermined order in which the inclinations of the face to be detected (step S34).

A predetermined resolution image S1′_i is selected from the resolution image group S1′ in the order in which the size becomes smaller, that is, in the order of S1′_n, S1′_n−1, . . . S1′_1, by the resolution selecting portion 52 under the control of the detection controlling portion 51 (step S35).

Then the detection controlling portion 51 sets the sub-window setting conditions for making the detection mode to a rough detection mode on the sub-window setting portion 53. By this, the sub-window setting portion 53 sets the sub-window on the resolution image S1′_i while moving at the wider pitches, e.g., the pitches of five pixels, and cuts out a predetermined size of a fraction image W1 (step S36).

The fraction image W1 is input into a determiner of the selected kind in the first determiner group 54. For example, when the inclination of the face to be detected is an inclination rotated at 30° about the vertical direction of the object image S0, the fraction image W1 is input into three determiners 54F_30, 54L_30, and 54R_30. These determiners 54F_30, 54L_30, and 54R_30 respectively calculate a score representing the probability that the input fraction image W1 is a face image. That is, the full face determiner calculates a score SC_F representing the probability that the input fraction image W1 is a full face image, the left side face determiner calculates a score SC_L representing the probability that the input fraction image W1 is a left side face image, and the right side face determiner calculates a score SC_R representing the probability that the input fraction image W1 is a right side face image (step S37).

The detection controlling portion 51 obtains these scores and determines whether the sum of these scores is not smaller than a threshold value SCth (step S38). When the answer in the determination is an affirmation, the fraction image W1 is determined to be a prospective face image, and the processing is shifted to step S39 to carry out the face detection in a fine mode. When the answer in the determination is a negation, the fraction image W1 is determined not to be a face image, and the processing is shifted to step S45 to determine whether the detection can be continued.

In step S39, the detection controlling portion 51 sets the sub-window setting conditions for making the detection mode to a fine detection mode limiting the detecting area to an area having a predetermined size including the fraction image W1 (a prospective face image) on the sub-window setting portion 53. By this, the sub-window setting portion 53 sets the sub-window in the vicinity of the fraction image W1 while moving at the narrow pitches, e.g., the pitches of one pixel, and cuts out a predetermined size of a fraction image W2 to input it into a determiner in the second determiner group 55 of the kind selected in step S34.

These determiners respectively calculate a score representing the probability that the input fraction image W2 is a face image. That is, the full face determiner calculates a score SC_F representing the probability that the input fraction image W2 is a full face image, the left side face determiner calculates a score SC_L representing the probability that the input fraction image W2 is a left side face image, and the right side face determiner calculates a score SC_R representing the probability that the input fraction image W2 is a right side face image (step S40). Then the detection controlling portion 51 obtains these score.

Then whether the current fraction image W2 is the last one in the vicinity of the prospective face image is determined (step S41). When it is determined in step S41 that the current fraction image W2 is not the last one in the vicinity of the prospective face image, the processing returns to step S39 to cut out a new fraction image W2 and continues the detection in the fine mode. When it is determined in step S41 that the current fraction image W2 is the last one, the processing shifts to step S42 and identifies the new fraction image W2 which is the largest in the sum of the calculated scores in a plurality of fraction images W2 cut out for one fraction image S1 determined to be a prospective face image.

Whether the sum of the scores of the identified fraction image W2 is not smaller than the threshold value SCth is determined. When the answer in the determination is an affirmation, the fraction image W1 is determined to be a face image, and the processing is shifted to step S44 to identify the orientation of the face. When the answer in the determination is a negation, the fraction image W2 is determined to be a non-face image, and the processing is shifted to step S45.

In step S44, ratio between the score of the full face SC_F, the score of the left side face SC_L, and the score of the right side face SC_R calculated for the identified fraction image W2 is obtained, and the orientation of the face is identified on the basis of the ratio.

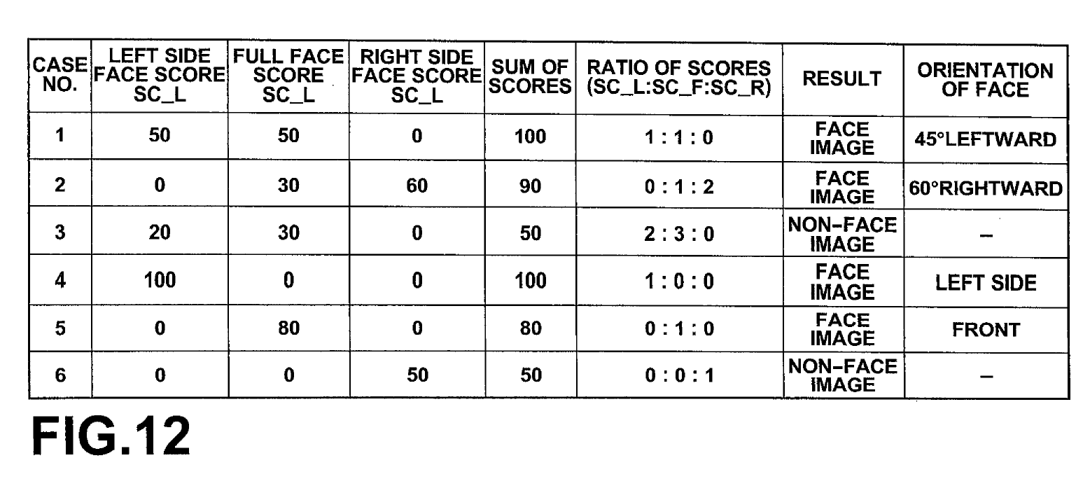

FIG. 12 is a view showing an example of the correspondence between the calculated scores and determination of whether the input image is a face image and orientation of the face identified. The threshold value SCth on the basis of which whether the input image is a face image is determined is 60 here. For example, as in the case 1 shown in FIG. 12, when the score of the left side face SC_L is 50, the score of the full face SC_F is 50 and the score of the right side face SC_R is 0, the fraction image W2 is determined to be a face image since the sum of the scores is 100 and larger than the threshold value SCth. Since the ratio, the score of the left side face: the score of the full face: the score of the right side face, is 1:1:0, the orientation of the face is identified to be a position where the left side face and the full face is divided into 1:1, i.e., a position rotated by 45° toward left. Further, as in the case 2, when the score of the left side face SC_L is 0, the score of the full face SC_F is 30 and the score of the right side face SC_R is 60, the fraction image W2 is determined to be a face image since the sum of the scores is 90 and larger than the threshold value SCth. Since the ratio, the score of the left side face: the score of the full face: the score of the right side face, is 0:1:2, the orientation of the face is identified to be a position where the left side face and the full face is divided into 1:2, i.e., a position rotated by 60° toward right (60° toward right from front). Further, as in the case 3, when the score of the left side face SC_L is 20, the score of the full face SC_F is 30 and the score of the right side face SC_R is 0, the fraction image W2 is determined to be a non-face image since the sum of the scores is 50 and smaller than the threshold value SCth. When the scores are not biased toward a predetermined orientation but evenly dispersed in all the orientations, a center of gravity of the calculated scores may be obtained so that the orientation corresponding to the center of gravity is taken as the orientation of the face.

In step S45, whether the current fraction image W1 is the last one is determined in the current resolution image. When it is determined in step S45 that the current fraction image W1 is not the last one, the processing returns to step S36 to cut out a new fraction image W1 from the current resolution image and continues the detection. When it is determined in step S45 that the current fraction image W1 is the last one, the processing shifts to step S46 and whether the current resolution image is the last one is determined in the current resolution image. When it is determined here that the current resolution image is not the last one, the processing returns to step S35 to select a new resolution image and continues the detection. When it is determined that the current resolution image is the last one, whether (step S47). When it is determined here that the currently selected determiner is not of the lastly ordered kind, the processing returns to step S34 to select a new next ordered kind of determiner and continues the detection. When it is determined that the currently selected determiner is of the lastly ordered kind, the detection is ended.

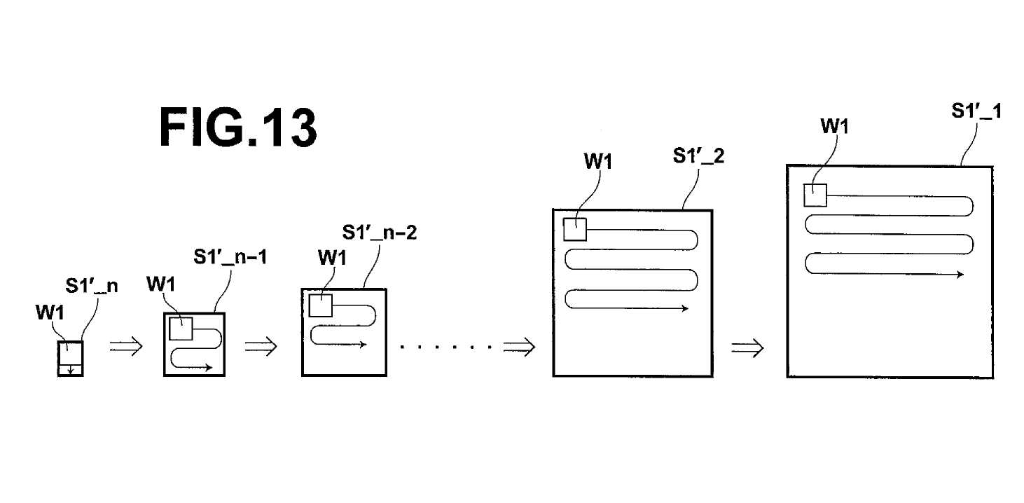

As shown in FIG. 13, by repeating step S35 to step S45, the resolution images are selected in the order in which the size becomes smaller and the fraction images W1 are cut out in sequence, whereby the face detection is performed.

In step S48, the double detection determining portion 60 carries out processing of integrating the face images which have been detected double in each real face image S2 and outputs real face images S3 detected in the input image S0.

In accordance with the face detecting system which is an embodiment of the present invention, since the indexes representing the probability that the input image is a face image including a face oriented in a predetermined orientation are calculated on the basis of a feature value on the image in the input image for each of different predetermined orientations, information on the probability that the input image is a face image and orientation thereof can be reflected on each of the indexes irrespective of the orientation of the face by the components corresponding to the different predetermined orientations, and since whether the input image is a face image including a face is determined on the basis of the sum of the indexes and at the same time the orientation of the face is identified on the basis of the ratio among the plurality of indexes, whether the input image is a face image can be determined and orientation of the face can be identified by only a simple evaluation of the plurality of indexes limited in number, whereby whether the relevant digital image is a face image can be determined and the orientation of the face can be identified in a short time.

Though, in this embodiment, determination of whether the fraction image is a face image and identification of the orientation of the face are both effected on the basis of the scores calculated by a plurality of kinds of determiners which are different in the orientation of the face to detect, for instance, in the case where though that the image is a face image is known, the orientation of the face is unknown, the scores may be similarly calculated by the use of a plurality of kinds of determiners which are different in the orientation of the face to detect so that the orientation of the face is identified by evaluating the ratio of the scores. That is, by the fewer kinds of determiners, a face can be detected and/or the orientation of the face can be identified.

Though a face detecting system in accordance with an embodiment of the present invention has been described above, a computer program for causing a computer to execute the processing corresponding to the detection of the face in accordance with the present invention is an embodiment of the present invention. Further, computer readable recording media on which such a computer program is recorded form an embodiment of the present invention. A skilled artisan would know that the computer readable medium is not limited to any specific type of storage devices and includes any kind of device, including but not limited to CDs, floppy disks, RAMs, ROMs, hard disks, magnetic tapes and internet downloads, in which computer instructions can be stored and/or transmitted. Transmission of the computer code through a network or through wireless transmission means is also within the scope of this invention. Additionally, computer code/instructions include, but are not limited to, source, object and executable code and can be in any language including higher level languages, assembly language and machine language.

What is claimed is:

1. A face orientation identifying method comprising the steps of
calculating an index representing the probability that an input image is a face image including a face oriented in a predetermined orientation for each of different predetermined orientations on the basis of a feature value of the input image including a face and
identifying the orientation of the face included in the input image on the basis of the ratio of the indexes which have been calculated for the different predetermined orientations.

2. A face orientation identifying method as defined in claim 1 in which the step of calculating the index is a step of calculating the index by the use of an index calculator which has learned features of the face oriented in the orientation with a plurality of sample images representing a face oriented in the orientation for each of the different predetermined orientations.

3. A face orientation identifying method as defined in claim 1 in which the different predetermined orientations is a front, a left side and a right side.

4. A face orientation identifying method as defined in claim 2 in which the different predetermined orientations is a front, a left side and a right side.

5. A face determining method comprising the steps of
calculating an index representing the probability that an input image is an image including a face oriented in a predetermined orientation for each of different predetermined orientations on the basis of a feature value of the input image,
determining whether the input image is an image including a face on the basis of the sum of the indexes which have been calculated for the different predetermined orientations and
identifying the orientation of the face included in the input image on the basis of the ratio of the calculated indexes when it has been determined that the input image is an image including a face.

6. A face determining method as defined in claim 5 in which the step of calculating the index is a step of calculating the index by the use of an index calculator which has learned features of the face oriented in the orientation with a plurality of sample images representing a face oriented in the orientation for each of the different predetermined orientations.

7. A face determining method as defined in claim 5 in which the different predetermined orientations is a front, a left side and a right side.

8. A face determining method as defined in claim 6 in which the different predetermined orientations is a front, a left side and a right side.

9. A face orientation identifying system comprising
an index calculating means which calculates an index representing the probability that an input image is a face image including a face oriented in a predetermined orientation for each of different predetermined orientations on the basis of a feature value of the input image including a face and
a face orientation identifying means which identifies the orientation of the face included in the input image on the basis of the ratio of the indexes which have been calculated for the different predetermined orientations.

10. A face orientation identifying system as defined in claim 9 in which the index calculating means calculates the index by the use of an index calculator which has learned features of the face oriented in the orientation with a plurality of sample images representing a face oriented in the orientation for each of the different predetermined orientations.

11. A face orientation identifying system as defined in claim 9 in which the different predetermined orientations is a front, a left side and a right side.

12. A face orientation identifying system as defined in claim 10 in which the different predetermined orientations is a front, a left side and a right side.

13. A face determining system comprising
an index calculating means which calculates an index representing the probability that an input image is an image including a face oriented in a predetermined orientation for each of different predetermined orientations on the basis of a feature value of the input image,
a face determining means which determines whether the input image is an image including a face on the basis of the sum of the indexes which have been calculated for the different predetermined orientations and identifies the orientation of the face included in the input image on the basis of the ratio of the calculated indexes when it has been determined that the input image is an image including a face.

14. A face determining system as defined in claim 13 in which the index calculating means calculates the index by the use of an index calculator which has learned features of the face oriented in the orientation with a plurality of sample images representing a face oriented in the orientation for each of the different predetermined orientations.

15. A face determining system as defined in claim 13 in which the different predetermined orientations is a front, a left side and a right side.

16. A face determining system as defined in claim 14 in which the different predetermined orientations is a front, a left side and a right side.

17. A computer-readable medium on which recorded a computer program for causing a computer to function as a face orientation identifying system by causing the computer to function as
an index calculating means which calculates an index representing the probability that an input image is a face image including a face oriented in a predetermined orientation for each of different predetermined orientations on the basis of a feature value of the input image including a face and
a face orientation identifying means which identifies the orientation of the face included in the input image on the basis of the ratio of the indexes which have been calculated for the different predetermined orientations.

18. A computer-readable medium as defined in claim 17 in which the index calculating means calculates the index by the use of an index calculator which has learned features of the face oriented in the orientation with a plurality of sample images representing a face oriented in the orientation for each of the different predetermined orientations.

19. A computer-readable medium on which recorded a computer program for causing a computer to function as a face determining system by causing the computer to function as
an index calculating means which calculates an index representing the probability that an input image is an image including a face oriented in a predetermined orientation for each of different predetermined orientations on the basis of a feature value of the input image,
a face determining means which determines whether the input image is an image including a face on the basis of the sum of the indexes which have been calculated for the different predetermined orientations and identifies the orientation of the face included in the input image on the basis of the ratio of the calculated indexes when it has been determined that the input image is an image including a face.
